(19) United States
(12) Patent Application Publication
(10) Pub. No.: US 2025/0104058 A1
(43) Pub. Date: Mar. 27, 2025

(54) METHOD AND SYSTEM OF INCREASING DIVERSITY IN BLOCKCHAIN SYSTEMS

(71) Applicant: Mastercard International Incorporated, Purchase, NY (US)

(72) Inventors: Avinash UPADHYAY, Noida (IN); Irshad Ahmad SIDDIQUEE, New Delhi (IN); Jaipal Singh KUMAWAT, Sikar, Rajasthan (IN)

(73) Assignee: Mastercard International Incorporated, Purchase, NY (US)

(21) Appl. No.: 18/373,370

(22) Filed: Sep. 27, 2023

(51) Int. Cl. G06Q 20/38; G06Q 20/36; G06Q 20/40

(52) U.S. Cl. CPC G06Q 20/3829; G06Q 20/3674; G06Q 20/405

(57) ABSTRACT

A method for reporting diversity compliance for participants in a blockchain network includes: receiving, by a blockchain node in the blockchain network, diversity data associated with a registered participant in a blockchain and generating a new block including the diversity data that is added to a sidechain to the blockchain. The blockchain includes a smart contract that when it detects addition of the generated new block to the sidechain or periodically self-executes to: analyze additional diversity data included in each of one or more blockchain data entries stored in the sidechain that are associated with the registered participant, generate a reporting message based on the analyzed additional diversity data, and transmit the generated reporting message to one or more external computing systems.

### FIELD

The present disclosure relates to increasing diversity in blockchains, specifically the use of sidechains and smart contracts to promote and/or enforce diversity in blockchain participants.

### BACKGROUND

Blockchain was initially created to provide a platform through which cryptographic currency could be traded. Two of major tenets in the creation of blockchain are that the blockchain itself would be entirely decentralized, being stored on and managed via a vast distribution of computing systems, and that the cryptocurrency transactions could be conducted with full anonymity, where no identification information needed to be provided to participant and all transactions were between blockchain wallets without regard for ownership thereof. These two tenets led to a large adoption in blockchain and its use in the creation and management of a vast number and variety of cryptographic currencies.

Another tenet of blockchain is that the data on the chain itself is immutable. Because of the complicated nature of adding new blocks to the blockchain, as well as the decentralized architecture, blocks that are added to the blockchain cannot be removed or modified, providing a valuable means of secure data storage. As a result, many uses for blockchains have been developed outside of cryptocurrency, such as the storage of ownership records, supply chain management, and logistics. The expansion of blockchain into different industries has led to a large influx of entities with a desire to utilize blockchain technology.

However, because of the anonymity provided to participants in a blockchain, it can be difficult to monitor or enforce desired characteristics or required regulations (collectively reference herein as requirements) for participants. For example, many industries and entities are interested in promoting diversity. In such cases, entities often prefer to work with other entities that promote or engage in actions that increase diversity or can provide incentives to entities that comply with desired diversity characteristics. Unfortunately, because of the anonymity in blockchains, it can be exceedingly difficult, if not impossible, for one participant to know the identity, let alone the compliance with desired characteristics, of another. Thus, there is a need for a technological solution to promote an increase in diversity of the participants in blockchains.

### SUMMARY

The present disclosure provides a description of systems and methods for reporting diversity compliance for participants in a blockchain network. A blockchain node in the blockchain network receives new diversity data associated with a participant registered with the blockchain of the blockchain network. The blockchain node can identify a sidechain to which the diversity data is to be stored and generate a new block for that sidechain that includes the diversity data as well as data identifying the associated participant. The block gets confirmed and added to the sidechain, which is detected by a smart contract on the blockchain that is associated with the participant. The smart contract analyzes the newly added diversity data and generates a reporting message regarding the diversity of the participant based thereon, which can, for example, indicate if the participant is compliant with applicable requirements regarding diversity. This reporting message is then transmitted to one or more external systems, such as regulatory agencies or other interested parties, which can then act on the new reporting.

A method for reporting diversity compliance for participants in a blockchain network includes: receiving, by a receiver of a blockchain node in the blockchain network, diversity data associated with a registered participant in a blockchain associated with the blockchain network; generating, by a processor of the blockchain node, a new block, wherein the new block includes at least one blockchain data entry and the at least one blockchain data entry includes at least the diversity data and identification data associated with the registered participant; and transmitting, by a transmitter of the blockchain node, the generated new block to a plurality of additional nodes in the blockchain network, wherein the plurality of additional nodes confirms the generated new block for addition to a sidechain to the blockchain, wherein the blockchain includes a blockchain data entry including a smart contract, the smart contract detects addition of the generated new block to the sidechain, the smart contract self-executes in response to detecting the addition of the generated new block, and self-execution of the smart contract includes: analyzing additional diversity data included in each of one or more blockchain data entries stored in the sidechain that include the identification data associated with the registered participant, generating a reporting message based on the analyzed additional diversity data, and transmitting the generated reporting message to one or more external computing systems.

A system for reporting diversity compliance for participants in a blockchain network includes: the blockchain network; a blockchain node in the blockchain network; a plurality of additional nodes in the blockchain network; and one or more external computing systems, wherein the blockchain node includes a receiver receiving diversity data associated with a registered participant in a blockchain associated with the blockchain network, a processor generating a new block, wherein the new block includes at least one blockchain data entry and the at least one blockchain data entry includes at least the diversity data and identification data associated with the registered participant, and a transmitter transmitting the generated new block to the plurality of additional nodes in the blockchain network, wherein the plurality of additional nodes confirms the generated new block for addition to a sidechain to the blockchain, the blockchain includes a blockchain data entry including a smart contract, the smart contract detects addition of the generated new block to the sidechain, the smart contract self-executes in response to detecting the addition of the generated new block, and self-execution of the smart contract includes: analyzing additional diversity data included in each of one or more blockchain data entries stored in the sidechain that include the identification data associated with the registered participant, generating a reporting message based on the analyzed additional diversity data, and transmitting the generated reporting message to the one or more external computing systems.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for reporting diversity compliance for participants in a blockchain network in accordance with exemplary embodiments.

FIG. 2 is a block diagram illustrating a blockchain node in the system of FIG. 1 for reporting diversity compliance for participants in a blockchain network in accordance with exemplary embodiments.

FIG. 3 is a flow diagram illustrating a process reporting diversity compliance in a blockchain network in the system of FIG. 1 in accordance with exemplary embodiments.

FIG. 4 is a flow chart illustrating an exemplary method for reporting diversity compliance for participants in a blockchain network in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Diversity Reporting for Blockchain Participants

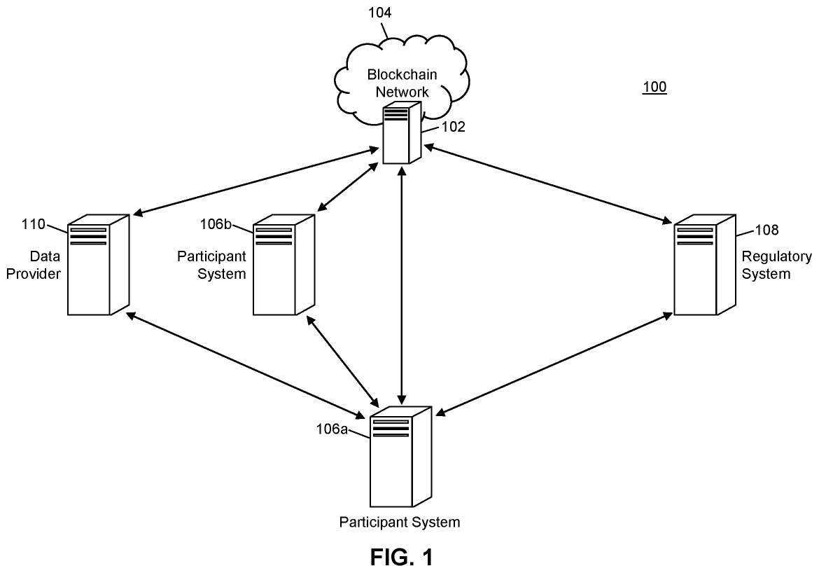

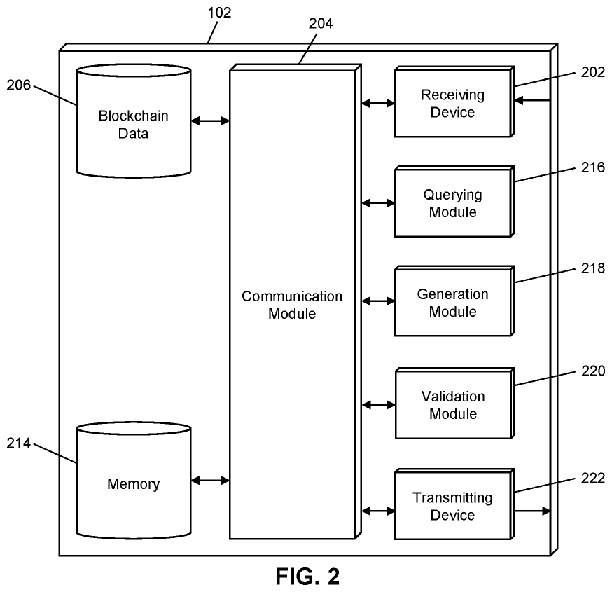

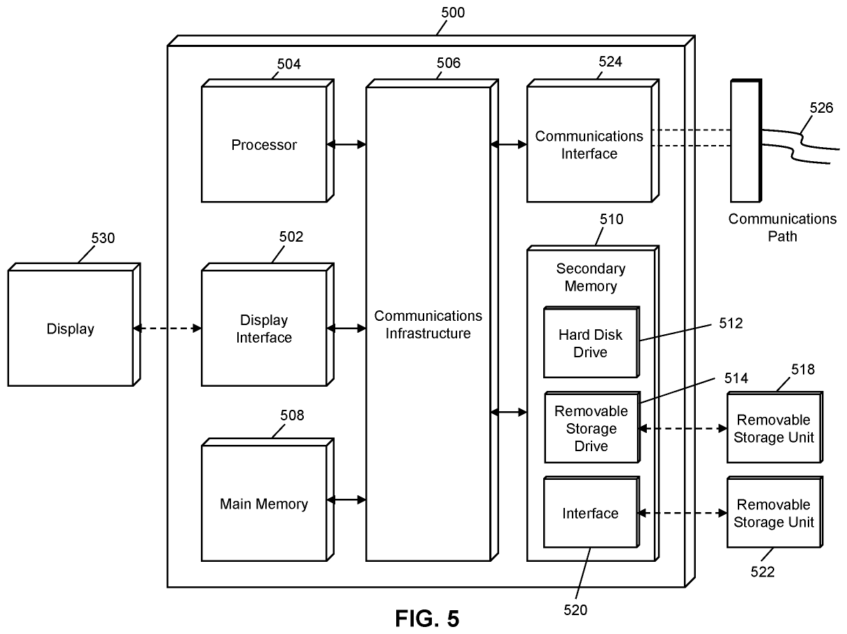

FIG. 1 illustrates a system 100 for the monitoring and reporting of diversity for participants in a blockchain. The system 100 can include a blockchain network 104. The blockchain network 104 can be comprised of a plurality of blockchain nodes 102. Each blockchain node 102 can be a computing system, such as illustrated in FIG. 2 or 5, discussed in more detail below, that is configured to perform functions related to the processing and management of the blockchain, including the generation of blockchain data values, verification of proposed blockchain transactions, verification of digital signatures, generation of new blocks, validation of new blocks, and maintenance of a copy of the blockchain.

The blockchain can be a distributed ledger that is comprised of at least a plurality of blocks. Each block can include at least a block header and one or more data values. Each block header can include at least a timestamp, a block reference value, and a data reference value. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 102 in a blockchain network 104 prior to the generation and addition of a new block to the blockchain in order for the change to be made permanent. Computational and communication limitations can make such a modification exceedingly difficult, if not impossible, thus rendering the blockchain immutable.

In some embodiments, the blockchain can be used to store information regarding blockchain transactions conducted between two different blockchain wallets. A blockchain wallet can include a private key of a cryptographic key pair that is used to generate digital signatures that serve as authorization by a payer for a blockchain transaction, where the digital signature can be verified by the respective blockchain network 104 using the public key of the cryptographic key pair. In some cases, the term “blockchain wallet” can refer specifically to the private key. In other cases, the term “blockchain wallet” can refer to a computing device (e.g., participant system 106) that stores the private key for use thereof in blockchain transactions. For instance, each computing device can each have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

Each blockchain data value stored in the blockchain can correspond to a blockchain transaction or other storage of data, as applicable. A blockchain transaction can consist of at least: a digital signature of the sender of that is generated using the sender's private key, a blockchain address of the recipient of currency generated using the recipient's public key, and a blockchain currency amount that is transferred, or other data being stored. In some blockchain transactions, the transaction can also include one or more blockchain addresses of the sender where blockchain currency (or other data) is currently stored (e.g., where the digital signature proves their access to such currency), as well as an address generated using the sender's public key for any change that is to be retained by the sender. For financial transactions, for instance, addresses to which cryptographic currency has been sent that can be used in future transactions are referred to as “output” addresses, as each address was previously used to capture output of a prior blockchain transaction, also referred to as “unspent transactions,” due to there being currency sent to the address in a prior transaction where that currency is still unspent. The same concept applies to nearly any other electronic record (e.g., non-fungible tokens (NFT), data files, providence records, etc.). In some cases, a blockchain transaction can also include the sender's public key, for use by an entity in validating the transaction. For the traditional processing of a blockchain transaction, such data can be provided to a blockchain node 102 in a blockchain network 104, either by the sender or the recipient. The node can verify the digital signature using the public key in the cryptographic key pair of the sender's wallet and also verify the sender's access to the funds (e.g., that the unspent transactions have not yet been spent and were sent to address associated with the sender's wallet), a process known as “confirmation” of a transaction, and then include the blockchain transaction in a new block. The new block can be validated by other blockchain nodes 102 in the blockchain network 104 before being added to the blockchain and distributed to all of the blockchain nodes 102 in the blockchain network 104, respectively, in traditional blockchain implementations. In cases where a blockchain data value cannot be related to a blockchain transaction, but instead the storage of other types of data, blockchain data values can still include or otherwise involve the validation of a digital signature.

In the system 100, participants in the blockchain of the blockchain network 104 can be monitored for diversity. The system 100 can include a plurality of participant systems 106, illustrated in FIG. 1 as participant systems 106a and 106b. Each participant system 106 can have a blockchain wallet that is used to participate in blockchain transactions on the blockchain associated with the blockchain network 104. In an example, the participant system 106a can participate in a blockchain transaction where the participant system 106a transfers an amount of cryptographic currency to the participant system 106b, or where the participant system 106b transfers ownership of a non-fungible token to the participant system 106a, for example. The participant systems 106 can be associated with entities for whom diversity information is to be collected.

Diversity information for participants in the blockchain can be collected for any suitable purpose. In an example, the system 100 can include a regulatory system 108, which can be associated with a government agency, oversight organization, or other entity that requests or requires compliance with one or more diversity requirements, guidelines, incentive programs, social platforms desires, investor desired investment profiles, or other interested entity, etc., collectively references as requirements herein. For instance, the regulatory system 108 can be a tax bureau that provides tax or other tax-related incentives for entities that comply with desired diversity requirements, but nearly any incentive is contemplated. In some cases, desired diversity characteristics can be provided to the blockchain nodes 102 in the blockchain network 104 using suitable communication networks and methods, such as can be provided by one or more regulatory systems 108. In other cases, the blockchain nodes 102 can report diversity data for participants to regulatory systems 108 or other applicable systems, where the regulatory systems 108 or other applicable systems can use the reported diversity data to determine compliance with applicable requirements or for other suitable purposes.

When new diversity information is available for a participant system 106, the diversity information can be provided to a blockchain node 102 in the blockchain network 104 using a suitable communication network and method. In some cases, diversity data can be self-reported by participant systems 106. In other cases, diversity data can be provided, supplemented, verified, etc., by one or more data providers 110. Data providers 110 can include any entities or systems that collect information regarding diversity of blockchain participants that can provide such information to blockchain nodes 102 for use in the methods discussed herein. Data providers 110 can include, for example, credit bureaus, public record agencies, compliance organizations, social networks, participants, investigative entities, etc. In some cases, a blockchain node 102 can use a data provider 110 to verify information that is reported by third parties or self-reported by a participant system 106 for accuracy thereof.

Diversity data received by a blockchain node 102 can include any data that can be useful in determining compliance with any suitable diversity requirements. Diversity data can include, for example, data regarding age, race, gender, nationality, citizenship, annual income, marital status, familial status, geographic location, or any other suitable data. In some cases, the diversity data can be bucketed, aggregated, anonymized, or otherwise formatted in a suitable manner to comply with any applicable data protection requirements. In some cases, diversity data regarding multiple categories can be provided, such as where a submission received by a blockchain node 102 can include information regarding age ranges, races, genders, nationalities, and citizenships, for instance, of all of the employees of a participant. In other cases, diversity data can be separated by category. For example, a participant system 106 can report information on the ages of all employees of the associated participant in a submission, and use separate submissions for other categories of diversity data, such as race, gender, nationality, etc.

In some cases, diversity data can include aggregated data, such as for an entire entity associated with a participant system 106 or group of individuals associated therewith. For example, a large business as a participant system 106 can report diversity data for gender statistics of all employees of the business. In other cases, diversity data can have any suitable level of granularity, such as being specific to individual employees of a business. In such a case, a participant system 106 can provide new diversity data for any employee of the associated entity. For example, when a new employee is hired, diversity data for that employee can be submitted to a blockchain node, and, if an employee is no longer with the entity, an update regarding removal of the employee can be provided to a blockchain node 102. In embodiments where diversity data regarding individual employees is received, the blockchain node 102 can request verification of the data, such as from the employees themselves or via a third-party service, such as a census provider, social networks, etc. In instances where diversity data regarding individuals can be supplied, the diversity data can also be in compliance with any requirements regarding the protection of personally identifiable information, such as through the use of bucketing, separation of categories of data for individuals, or other suitable methods.

In some cases, diversity data can be provided to a blockchain node 102 by the participant system 106 or other system whenever a change in status occurs for the participant system 106, such as the hiring or termination of an employee. In other cases, a participant system 106 can periodically provide diversity data to a blockchain node 102, such as daily, weekly, monthly etc. In some embodiments, a period for updating diversity data can be specified by regulatory systems 108 or other suitable systems and/or entities. For example, a certifying association can require monthly updates to diversity data in order to maintain a certification of a specific diversity characteristic with the association.

When a blockchain node 102 receives new diversity data, the blockchain node 102 can generate a new block that includes a blockchain data entry that includes the new diversity data. The blockchain data entry can also include identifying information that identifies the participant with which the diversity data is associated. In one embodiment, the identifying information can include a public key of the cryptographic key pair that constitutes the blockchain wallet for the participant system 106. In other embodiments, the identifying information can include merchant identification numbers, tax identification numbers, business names, or other suitable identifying value(s). In cases where new diversity data consists of the removal of an existing employee, the new blockchain data entry can include an indication of the negation of prior diversity data associated with that employee, such as by indicating the prior blockchain data entry that is negated, or by indicating removal of specific diversity stats overall for the participant. In some embodiments, the blockchain node 102 can be configured to update existing diversity data with the new diversity data. In such embodiments, the blockchain node 102 can identify the most recent blockchain data entry that was added for the participant, update the diversity data included therein using the new diversity data (e.g., by replacing values with new values, incrementing or decrementing values based on the hiring or removal of new employees, etc.), and use the updated diversity data in the new blockchain data entry. In such an instance, the newest blockchain data entry for a participant can always include the most up-to-date overall diversity information for that participant.

Once the new block is generated that includes the new blockchain data entry, the block can be distributed to a plurality of additional blockchain nodes 102 in the blockchain network 104 for verification, confirmation, and addition to the blockchain. In some embodiments, blocks that include diversity data can be stored in one or more sidechains to the blockchain. In some embodiments, a single sidechain can be used to store all diversity data for all participants. In other embodiments, separate sidechains can be used for each participant in the blockchain. In still other embodiments, separate sidechains can be used for separate diversity categories, such as a sidechain for all age information for participants, a sidechain for all gender information for participants, etc. Of course, there can be multiple sidechains in other embodiments and a mix of these different embodiments. Advantages of the sidechains are that they do not increase the size of the main chain that might otherwise be slower in respond to inquiries, etc., particularly because the main chain is used for a different purpose (financial transactions, legal records, providence, supply chain logistics, and nearly any other use for which blockchains have been or will be used. Additionally, the side chains can have different levels of permissions (from open, partially open, partially closed or closed for instance), differing protocols regarding data format, encryption of data, hashing algorithms, proof of work, proof of stake, other consensus protocols, and nearly any other parameter, but still able to communicate participate information and reporting between main and side chains. When a participate in active on the main chain, a check of the entity's status can be checked or periodically checked on the appropriate sidechain(s).

In the system 100, a smart contract can be added to the blockchain (or a sidechain, such as a diversity sidechain discussed above, or a separate sidechain used for smart contracts) for every participant in the blockchain for which diversity information is to be collected. In some cases, the smart contract can be automatically generated during a registration process, such as when the associated participant system 106 first generates or is assigned its blockchain wallet. The smart contract can be configured to monitor for new blockchain data entries in the blockchain or any sidechains that include identifying information associated with a specific participant. When a new blockchain data entry is added to the blockchain or sidechain that is associated with that participant (e.g., identifying by its inclusion of the identifying information), the smart contract can self-execute as a result of the detection of the new blockchain data entry. Self-execution of the smart contract can result in analysis of the diversity data included therein and generation of a reporting message, where the reporting message can include information regarding the diversity of the associated participant. In cases where the newest blockchain data entry is updated to always have the most up-to-date diversity data, the smart contract can use just the newest blockchain data entry. In other cases, the smart contract can identify all blockchain data entries that include the identifying information for the participant and analyze the diversity data included in all of the identified blockchain data entries.

The reporting message generated by the smart contract can include a summarization of the diversity data, one or more metrics generated regarding diversity of the associated participant, one or more determinations regarding compliance of the participant with one or more applicable regulations or guidelines, or any other suitable data as may be required or requested by regulatory systems 108, participant systems 106, or other interested systems. In one example, when a participant system 106 provides an update as to the races of employees of the associated participant, the smart contract can generate a reporting message that includes the percentages of employees of the associated participant broken down by race in accordance with all available diversity data, which can be provided to an entity that provides incentives to companies that meet desired racial diversity characteristics. In another example, the smart contract can generate a reporting message that indicates compliance or non-compliance of the associated participant with desired racial diversity characteristics based on the available diversity data, which can also include the percentages or other data, or only include the indication of compliance or non-compliance.

After the reporting message is generated, the smart contract can also initiate transmission of the reporting message to one or more external computing systems, such as the regulatory system 108, participant systems 106, or other suitable systems. As a result, when there is an update regarding the diversity of a participant in a blockchain, any interested entity can automatically receive a real-time update as to the diversity information of the participant. By using a smart contract, updates can be automatically identified and reporting automatically performed without any intervention or action by any entities in the system beyond the initial submission by the participant system 106, data provider 110, or other entity.

Once the diversity data has been reported, the regulatory system 108 or other entity can use the data in any suitable manner. In one example, a tax agency can provide tax breaks or other incentives to a participant that complies with one or more desired guidelines. In another example, a monitoring organization can revoke a minority business status for a participant that does not maintain a specific diversity guideline. In some cases, a participant system 106 associated with a participant can be blocked from participation in the blockchain if one or more diversity requirements are not met. In such cases, new blockchain transactions attempted by the participant system 106 can always be rejected or denied until compliance with the one or more diversity requirements is met. In some instances, the blockchain network 104 can use diversity to reward miners that are participating in the blockchain network 104. In such instances, miners that participate in requested diversity characteristics for employees can be provided with an advantage in mining or be provided better award rates, or miners that do not participate can be disadvantaged or banned from mining some or all new blocks. In some cases, diversity data can be maintained for miners of the blockchain network 104 where miners can be selected to achieve desired diversity characteristics.

The methods and systems discussed herein provide for automatic and efficient reporting of diversity compliance for participants in blockchains. The use of a blockchain and/or sidechains to store diversity data ensures that the data is immutable and cannot be edited or revised by a participant in a manner to game or take advantage of the system. The use of smart contracts provides for automatic analysis and reporting of diversity information in real-time anytime an update is made, without the need for modification to existing systems for entities or the involvement of additional entities. When combined with the immutability of the blockchain, this results in information that is provided quickly and with great accuracy, ensuring compliance of blockchain participants with any applicable desired or required characteristics can be checked at or in near real-time with minimal expenditure of time and resources by involved entities, providing a significant improvement over existing systems.

### Blockchain Nodes

FIG. 2 illustrates an embodiment of a blockchain node 102 in the system 100 of FIG. 1. It will be apparent to persons having skill in the relevant art that the embodiment of the blockchain node 102 illustrated in FIG. 2 is provided as illustration only and cannot be exhaustive to all possible configurations of the blockchain node 102 suitable for performing the functions as discussed herein. For example, the computer system 500 illustrated in FIG. 5 and discussed in more detail below can be a suitable configuration of the blockchain node 102. In some cases, other components of the system 100, such as the participant systems 106, regulatory system 108, or data provider 110 can include the components illustrated in FIG. 2 and discussed below.

The blockchain node 102 can include a receiving device 202. The receiving device 202 can be configured to receive data over one or more networks via one or more network protocols. In some instances, the receiving device 202 can be configured to receive data from other blockchain nodes 102, participant systems 106, regulatory systems 108, data providers 110, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by other blockchain nodes 102 that are superimposed or otherwise encoded with blockchain data entries, requests for blockchain data, confirmation messages, cryptographic keys, sidechain data, smart contracts, etc. The receiving device 202 can also be configured to receive data signals electronically transmitted by participant systems 106 and/or data providers 110 that can be superimposed or otherwise encoded with new blockchain transactions, diversity data, requests for diversity reporting, blockchain wallet registration data, identifying information, etc. The receiving device 202 can also be configured to receive data signals electronically transmitted by regulatory systems 110, which can be superimposed or otherwise encoded with desired or required diversity characteristics, reporting information, compliance data, identifying information, diversity data requests, etc.

The blockchain node 102 can also include a communication module 204. The communication module 204 can be configured to transmit data between modules, engines, databases, memories, and other components of the blockchain node 102 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the blockchain node 102 and external components of the blockchain node 102, such as externally connected databases, display devices, input devices, etc. The blockchain node 102 can also include a processing device. The processing device can be configured to perform the functions of the blockchain node 102 discussed herein as will be apparent to persons having skill in the relevant art. In some embodiments, the processing device can include and/or be comprised of a plurality of engines and/or modules specially configured to perform one or more functions of the processing device, such as a querying module 216, generation module 218, validation module 220, etc. As used herein, the term “module” can be software or hardware particularly programmed to receive an input, perform one or more processes using the input, and provides an output. The input, output, and processes performed by various modules will be apparent to one skilled in the art based upon the present disclosure.

The blockchain node 102 can also include blockchain data 206, which can be stored in a memory 214 of the processing server 102 or stored in a separate area within the blockchain node 102 or accessible thereby. The blockchain data 206 can include a blockchain, which may be comprised of a plurality of blocks and be associated with the blockchain network 104 and a blockchain. In cases where one or more sidechains can be used in the blockchain network, the blockchain data 206 can further include the sidechain(s) and plurality of blocks comprising each sidechain. In some cases, the blockchain data 206 can further include any other data associated with the blockchain and management and performance thereof, such as block generation algorithms, digital signature generation and confirmation algorithms, communication data for blockchain nodes 102, smart contracts, cryptographic keys, etc.

The blockchain node 102 can also include a memory 214. The memory 214 can be configured to store data for use by the blockchain node 102 in performing the functions discussed herein, such as public and private keys, symmetric keys, etc. The memory 214 can be configured to store data using suitable data formatting methods and schema and can be any suitable type of memory, such as read-only memory, random access memory, etc. The memory 214 can include, for example, encryption keys and algorithms, communication protocols and standards, data formatting standards and protocols, program code for modules and application programs of the processing device, and other data that can be suitable for use by the blockchain node 102 in the performance of the functions disclosed herein as will be apparent to persons having skill in the relevant art. In some embodiments, the memory 214 can be comprised of or can otherwise include a relational database that utilizes structured query language for the storage, identification, modifying, updating, accessing, etc. of structured data sets stored therein. The memory 214 can be configured to store, for example, diversity categories, desired or required diversity characteristics, formatting information, communication information for reporting, etc.

The blockchain node 102 can include a querying module 216. The querying module 216 can be configured to execute queries on databases to identify information. The querying module 216 can receive one or more data values or query strings and can execute a query string based thereon on an indicated database, such as the blockchain data 206 of the blockchain node 102 to identify information stored therein. The querying module 216 can then output the identified information to an appropriate engine or module of the blockchain node 102 as necessary. The querying module 216 can, for example, execute a query on the blockchain data 206 to identify a past blockchain data entry that includes identifying information included with newly received diversity data for use in generating an updated set of diversity data for a new blockchain data entry.

The blockchain node 102 can also include a generation module 218. The generation module 218 can be configured to generate data for use by the blockchain node 102 in performing the functions discussed herein. The generation module 218 can receive instructions as input, can generate data based on the instructions, and can output the generated data to one or more modules of the blockchain node 102. For example, the generation module 218 can be configured to generate smart contracts, blockchain data entries, blocks, confirmation messages, diversity data analysis, reporting messages, compliance reports, etc.

The blockchain node 102 can also include a validation module 220. The validation module 220 can be configured to perform data validations and verifications for the blockchain node 102 as part of the functions discussed herein. The validation module 220 can receive instructions as input, can perform data validations or verification as instructed, and can output a result of the data validations or verifications to one or more modules of the blockchain node 102. In some cases, the input can include the data to be validated or verified and/or data to be used in the validation or verification. In other cases, the validation module 220 can be configured to identify such data, such as in the blockchain data 206 and/or memory 214. The validation module 220 can be configured to, for example, verify diversity compliance, validate new blockchain data entries and/or blocks, verify digital signatures, etc.

The blockchain node 102 can also include a transmitting device 222. The transmitting device 222 can be configured to transmit data over one or more networks via one or more network protocols. In some instances, the transmitting device 222 can be configured to transmit data to other blockchain nodes 102, participant systems 106, regulatory systems 108, data providers 110, and other entities via one or more communication methods, local area networks, wireless area networks, cellular communication, Bluetooth, radio frequency, the Internet, etc. In some embodiments, the transmitting device 222 can be comprised of multiple devices, such as different transmitting devices for transmitting data over different networks, such as a first transmitting device for transmitting data over a local area network and a second transmitting device for transmitting data via the Internet. The transmitting device 222 can electronically transmit data signals that have data superimposed that can be parsed by a receiving computing device. In some instances, the transmitting device 222 can include one or more modules for superimposing, encoding, or otherwise formatting data into data signals suitable for transmission.

The transmitting device 222 can be configured to electronically transmit data signals to other blockchain nodes 102 that are superimposed or otherwise encoded with blockchain data entries, blockchain data requests, blocks, confirmation messages, response messages, etc. The transmitting device 222 can also be configured to electronically transmit data signals to participant systems 106, which can be superimposed or otherwise encoded with diversity data requests, cryptographic key pairs, transaction notifications, blockchain data, reporting messages, etc. The transmitting device 222 can also be configured to electronically transmit data signals to regulatory systems 108 that can be superimposed or otherwise encoded with diversity characteristic requests, reporting messages, communication requests, etc. The transmitting device 222 can also be configured to electronically transmit data signals to data providers 110, which can be superimposed or otherwise encoded with requests for diversity data, which can include identifying information associated with the participant for which diversity data is being requested.

### Process for Diversity Reporting for Blockchain Participants

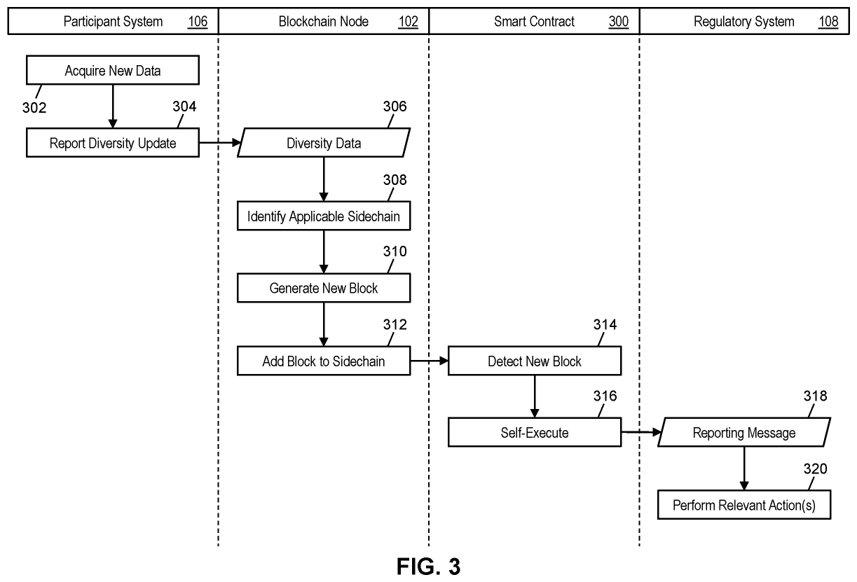

FIG. 3 illustrates a process in the system 100 of FIG. 1 for the reporting of diversity compliance for a participant system 106 in the blockchain associated with the blockchain network 104 through the use of a smart contract 300 stored on the blockchain or an applicable sidechain.

In step 302, the participant system 106 can acquire new diversity data, such as regarding diversity of employees of the associated entity, participants in a blockchain operated by the participant system 106, customers of the associated entity, etc. In step 304, the participant system 106 can report a diversity update to a blockchain node 102 in the blockchain network 104 using the new diversity data, which can also include the identifying information associated with the participant, such as the public key of the blockchain wallet of the participant system 106. The report can be electronically transmitted to the blockchain node 102 using any suitable communication network or method. In step 306, the receiving device 202 of the blockchain node 102 can receive the new diversity data from the participant system 106.

In step 308, the blockchain node 102 can identify the applicable sidechain to which the new diversity data is to be added. In cases where there is a sidechain for each participant, the blockchain node 102 can identify the sidechain associated with the participant associated with the participant system 106, such as using the received identifying information. In cases where there is a sidechain for each diversity category, the blockchain node 102 can identify each sidechain for any diversity categories for which new diversity data was received. In step 310, the generation module 218 of the blockchain node 102 can generate a new blockchain data entry that includes the new diversity data and identifying information and generate a new block that includes the new blockchain data entry. In cases where the diversity data includes multiple diversity categories and each diversity category has its own sidechain, the blockchain node 102 can generate separate blocks and blockchain data entries for each sidechain that includes the applicable diversity data. In step 312, the new block(s) can be added to the applicable, identified sidechain(s) using traditional methods.

In step 314, the smart contract 300, which can be stored on the blockchain or the applicable sidechain(s) can detect that a new block was added to the sidechain that includes a blockchain data entry that includes the identifying information associated with the participant associated with the participant system 106. Upon detection of the new block, the smart contract 300 can, in step 316, self-execute. Self-execution of the smart contract 300 can result in the analysis of diversity data for the participant that includes at least analysis of the new diversity data included in the newly added blockchain data entry. For instance, various desired diversity characteristics can be coded into the smart contract, and data similarly coded checked against those characteristics. For instance, for binary indications such as the existence of an equity, diversity, inclusion, and governance program (whether at all or by individual features), some form of certification of diversity by a third-party provider (e.g., certification, award, acclaim by industry, etc.) related to a participant can be check, statistical information such as categorized populations can be checked (through comparison script) against ranges or tiers, grown or shrinkage of these populations can also be compared to ranges or tier, as scripted in the smart contract. The smart contract can then output a value, whether binary or on a scale, for instance, 1-100. The input can be accomplished by survey style questionnaire format that might be structured as a series of decision trees, for instance. Natural language processing of input and output is contemplated.

Following the analysis, the smart contract 300 can generate a reporting message based on the analysis and electronically transmit the reporting message to the regulatory system 108. In step 318, the regulatory system 108 can receive the reporting message as provided by the smart contract 300. Additionally, this report can be used to report to other entities. It can trigger responses by the regulatory system 108 or other entities to set incentives or other participation parameters, and possibly report back the participants a rating with or without details of the finding for possible correction or contest, and/or instructions as to how to improve on the entity's diversity. In step 320, the regulatory system 108 can then perform any relevant actions as a result of the diversity report, such as by providing incentives to the participant, rewarding the participant, disadvantageng or fining the participant, sanctioning the participant, etc.

### Exemplary Method for Reporting Diversity Compliance

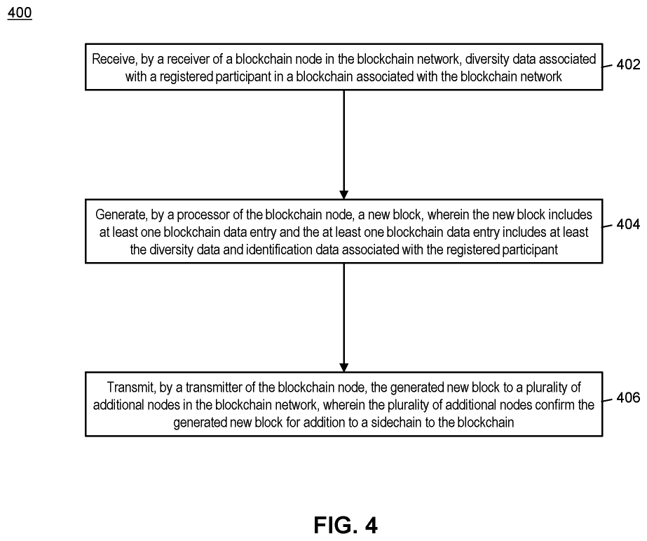

FIG. 4 illustrates a method 400 for the reporting of diversity data for compliance for a participant in a blockchain through the use of a sidechain and smart contract.

In step 402, diversity data associated with a registered participant in a blockchain associated with a blockchain network (e.g., blockchain network 104) can be received by a receiver (e.g., receiving device 202) of a blockchain node (e.g., blockchain node 102) in the blockchain network. In step 404, a new block can be generated by a processor (e.g., generation module 218) of the blockchain node, wherein the new block includes at least one blockchain data entry and the at least one blockchain data entry includes at least the diversity data and identification data associated with the registered participant. In step 406, the generated new block can be transmitted by a transmitter (e.g., transmitting device 222) of the blockchain node to a plurality of additional nodes in the blockchain network, wherein the plurality of additional nodes confirms the generated new block for addition to a sidechain to the blockchain.

The blockchain can include a blockchain data entry that includes a smart contract. When the generated new block is added to the blockchain, in step 406, the smart contract can detect addition of the generated new block to the sidechain and, in response to the detection, can self-execute. It can alternatively or additionally self-execute periodically, such as hourly, daily, weekly, monthly, yearly, etc. Self-execution of the smart contract can include: analyzing additional diversity data included in each of one or more blockchain data entries stored in the sidechain that include the identification data associated with the registered participant; generating a reporting message based on the analyzed additional diversity data, and transmitting the generated reporting message to one or more external computing systems (e.g., regulatory system 108, participant system 106, etc.).

In one embodiment, the identification data can be a public key of a blockchain wallet associated with the registered participant. In a further embodiment, the public key can be received by the receiver of the blockchain node with the diversity data. In some embodiments, the method 400 can further include identifying, by the processor (e.g., querying module 216) of the blockchain node, the sidechain from a plurality of sidechains based on the diversity data. In a further embodiment, each sidechain of the plurality of sidechains can be associated with a diversity category.

In one embodiment, the reporting message can indicate compliance or non-compliance with one or more diversity requirements based on the analyzed additional diversity data. In a further embodiment, the one or more external computing systems can include the plurality of additional nodes in the blockchain network. In an even further embodiment, each of the plurality of additional nodes can be configured to reject new blockchain transactions associated with the registered participant if the reporting message indicates non-compliance with the one or more diversity requirements.

### Computer System Architecture

FIG. 5 illustrates a computer system 500 in which embodiments of the present disclosure, or portions thereof, can be implemented as computer-readable code. For example, the blockchain nodes 102, participant systems 106, regulatory system 108, and data provider 110 can be implemented in the computer system 500 using hardware, non-transitory computer readable media having instructions stored thereon, or a combination thereof and can be implemented in one or more computer systems or other processing systems. Hardware can embody modules and components used to implement the methods of FIGS. 3 and 4.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 504 can be a special purpose or a general purpose processor device specifically configured to perform the functions discussed herein to be a special purpose computer. The processor device 504 can be connected to a communications infrastructure 506, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 can also include a main memory 508 (e.g., random access memory, read-only memory, etc.), and can also include a secondary memory 510. The secondary memory 510 can include the hard disk drive 512 and a removable storage drive 514, such as a floppy disk drive, a magnetic tape drive, an optical disk drive, a flash memory, etc.

The removable storage drive 514 can read from and/or write to the removable storage unit 518 in a well-known manner. The removable storage unit 518 can include a removable storage media that can be read by and written to by the removable storage drive 514. For example, if the removable storage drive 514 is a floppy disk drive or universal serial bus port, the removable storage unit 518 can be a floppy disk or portable flash drive, respectively. In one embodiment, the removable storage unit 518 can be non-transitory computer readable recording media.

In some embodiments, the secondary memory 510 can include alternative means for allowing computer programs or other instructions to be loaded into the computer system 500, for example, the removable storage unit 522 and an interface 520. Examples of such means can include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 500 can also include a communications interface 524. The communications interface 524 can be configured to allow software and data to be transferred between the computer system 500 and external devices. Exemplary communications interfaces 524 can include a modem, a network interface (e.g., an Ethernet card), a communications port, a PCMCIA slot and card, etc. Software and data transferred via the communications interface 524 can be in the form of signals, which can be electronic, electromagnetic, optical, or other signals as will be apparent to persons having skill in the relevant art. The signals can travel via a communications path 526, which can be configured to carry the signals and can be implemented using wire, cable, fiber optics, a phone line, a cellular phone link, a radio frequency link, etc.

The computer system 500 can further include a display interface 502. The display interface 502 can be configured to allow data to be transferred between the computer system 500 and external display 530. Exemplary display interfaces 502 can include high-definition multimedia interface (HDMI), digital visual interface (DVI), video graphics array (VGA), etc. The display 530 can be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 508 and secondary memory 510, which can be memory semiconductors (e.g., DRAMs, etc.). These computer program products can be means for providing software to the computer system 500. Computer programs (e.g., computer control logic) can be stored in the main memory 508 and/or the secondary memory 510. Computer programs can also be received via the communications interface 524. Such computer programs, when executed, can enable computer system 500 to implement the present methods as discussed herein. In particular, the computer programs, when executed, can enable processor device 504 to implement the methods illustrated by FIGS. 3 and 4, as discussed herein. Accordingly, such computer programs can represent controllers of the computer system 500. Where the present disclosure is implemented using software, the software can be stored in a computer program product and loaded into the computer system 500 using the removable storage drive 514, interface 520, and hard disk drive 512, or communications interface 524.

The processor device 504 can comprise one or more modules or engines configured to perform the functions of the computer system 500. Each of the modules or engines can be implemented using hardware and, in some instances, can also utilize software, such as corresponding to program code and/or programs stored in the main memory 508 or secondary memory 510. In such instances, program code can be compiled by the processor device 504 (e.g., by a compiling module or engine) prior to execution by the hardware of the computer system 500. For example, the program code can be source code written in a programming language that is translated into a lower level language, such as assembly language or machine code, for execution by the processor device 504 and/or any additional hardware components of the computer system 500. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for reporting diversity compliance for participants in a blockchain network. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for reporting diversity compliance for participants in a blockchain network, comprising:
receiving, by a receiver of a blockchain node in the blockchain network, diversity data associated with a registered participant in a blockchain associated with the blockchain network;
generating, by a processor of the blockchain node, a new block, wherein the new block includes at least one blockchain data entry and the at least one blockchain data entry includes at least the diversity data and identification data associated with the registered participant; and
transmitting, by a transmitter of the blockchain node, the generated new block to a plurality of additional nodes in the blockchain network, wherein the plurality of additional nodes confirms the generated new block for addition to a sidechain to the blockchain, wherein
the blockchain includes a blockchain data entry including a smart contract,
the smart contract self-executes, and
self-execution of the smart contract includes:
analyzing additional diversity data included in each of one or more blockchain data entries stored in the sidechain that include the identification data associated with the registered participant,
generating a reporting message based on the analyzed additional diversity data, and
transmitting the generated reporting message to one or more external computing systems.

2. The method of claim 1, wherein the identification data is a public key of a blockchain wallet associated with the registered participant.

3. The method of claim 2, wherein the public key is received by the receiver of the blockchain node with the diversity data.

4. The method of claim 1, further comprising:
identifying, by the processor of the blockchain node, the sidechain from a plurality of sidechains based on the diversity data.

5. The method of claim 4, wherein each sidechain of the plurality of sidechains is associated with a diversity category.

6. The method of claim 1, wherein the reporting message indicates compliance or non-compliance with one or more diversity requirements based on the analyzed additional diversity data.

7. The method of claim 6, wherein the one or more external computing systems includes the plurality of additional nodes in the blockchain network.

8. The method of claim 7, wherein each of the plurality of additional nodes are configured to reject new blockchain transactions associated with the registered participant if the reporting message indicates non-compliance with the one or more diversity requirements.

9. The method of claim 1, wherein the smart contract detects addition of the generated new block to the sidechain, and the smart contract self-executes in response to detecting the addition of the generated new block.

10. The method of claim 1, wherein the smart contract self-executes periodically.

11. A system for reporting diversity compliance for participants in a blockchain network, comprising:
the blockchain network;
a blockchain node in the blockchain network;
a plurality of additional nodes in the blockchain network; and
one or more external computing systems, wherein
the blockchain node includes
a receiver receiving diversity data associated with a registered participant in a blockchain associated with the blockchain network,
a processor generating a new block, wherein the new block includes at least one blockchain data entry and the at least one blockchain data entry includes at least the diversity data and identification data associated with the registered participant, and
a transmitter transmitting the generated new block to the plurality of additional nodes in the blockchain network, wherein the plurality of additional nodes confirm the generated new block for addition to a sidechain to the blockchain,
the blockchain includes a blockchain data entry including a smart contract,
the smart contract self-executes, and
self-execution of the smart contract includes:
analyzing additional diversity data included in each of one or more blockchain data entries stored in the sidechain that include the identification data associated with the registered participant,
generating a reporting message based on the analyzed additional diversity data, and
transmitting the generated reporting message to the one or more external computing systems.

12. The system of claim 11, wherein the identification data is a public key of a blockchain wallet associated with the registered participant.

13. The system of claim 12, wherein the public key is received by the receiver of the blockchain node with the diversity data.

14. The system of claim 11, wherein the processor of the blockchain node identifies the sidechain from a plurality of sidechains based on the diversity data.

15. The system of claim 14, wherein each sidechain of the plurality of sidechains is associated with a diversity category.

16. The system of claim 11, wherein the reporting message indicates compliance or non-compliance with one or more diversity requirements based on the analyzed additional diversity data.

17. The system of claim 16, wherein the one or more external computing systems includes the plurality of additional nodes in the blockchain network.

18. The system of claim 17, wherein each of the plurality of additional nodes are configured to reject new blockchain transactions associated with the registered participant if the reporting message indicates non-compliance with the one or more diversity requirements.

19. The system of claim 11, wherein the smart contract detects addition of the generated new block to the sidechain, and the smart contract self-executes in response to detecting the addition of the generated new block.

20. The system of claim 11, wherein the smart contract self-executes periodically.
